(19) United States
(12) Patent Application Publication
(10) Pub. No.: US 2023/0398672 A1
(43) Pub. Date: Dec. 14, 2023

(54) Aiming apparatus for nail gun or screw gun

(71) Applicants: Rose Tien Nguyen, San Jose, CA (US); Brian Tri Nguyen, San Jose, CA (US)

(72) Inventors: Rose Tien Nguyen, San Jose, CA (US); Brian Tri Nguyen, San Jose, CA (US)

(21) Appl. No.: 18/102,759

(22) Filed: Jan. 29, 2023

(51) Int. Cl. B25C 7/00

(52) U.S. Cl. CPC B25C 7/00

(57) ABSTRACT

An aiming apparatus for nail gun or screw gun includes two or more light pointers. The first light pointer is showing the aiming location of the nail or screw, other light pointers referencing to the last nail or the last screw. The first plate holds the light pointers. The second plate secures the first plate in place. And a belt tightens the aiming apparatus on the nail gun or screw gun.

### BACKGROUND OF THE INVENTION

### 1. Field of the Invention

The present invention is in the field of nail gun or screw gun and pertains particularly to an aiming apparatus for the nail gun or the screw gun.

### 2. Description of Related Art

Nail guns and screw guns are popular tools for housing construction. There are many different types that have been developed for framing, siding and dry walls.

A problem with the traditional nail gun and screw gun is that there is no aiming fixture which the user can control the distance from nail to nail or screw to screw. Most of the time, the contractors use their experience to control the distance between nails or screws. It is common to fail during inspections because the distance of the nails and screws do not meet the specs.

Therefore, to increase the accuracy of the distance between nails and screws, it is necessary to have an aiming apparatus for the nail gun and screw gun.

### BRIEF SUMMARY OF THE INVENTION

In one embodiment of the present invention a aiming apparatus for nail gun or screw gun is provided, comprising two or more light pointers, wherein the first light pointer showing the aiming location of nail or screw, other light pointers referencing to the last nail or the last screw, the first plate to hold the light pointers, the second plate to secure the first plate in place, and a belt to tighten the aiming apparatus on the nail gun or screw gun.

Also in one embodiment the aiming apparatus has three light pointers, the first light pointer showing the aiming location of the nail or screw, the second light pointer referencing to the last vertical nail or screw, the third light pointer referencing to the last horizontal nail or screw. Also in one embodiment the distance between light beams of light pointers are adjustable. Also in one embodiment the light pointers are laser pointers or LED pointers.

Also in one embodiment the first plate is L shape. The first plate comprises a hole with thread to secure the first light pointer in place, and the first pin for the second light pointer rotation to change the distance between the first light beam and the second light beam vertically, a thumb nut to tighten the second light pointer in place. And a second pin is for the third light pointer rotation to change the distance between the first light beam and the third light beam horizontally, a thumb nut to tighten the third light pointer in place. The second light pointer and the third light pointer comprise a hole for rotation and a shoulder threaded pin for tighten in place.

Also in one embodiment the second plate comprises a pin for the first plate rotation and a thumb nut to tighten the first plate in place. The first plate comprises a hole for rotation to adjust the location of the first light beam and a shoulder threaded pin for tighten in place.

Also in one embodiment the belt attaches to a latch to tighten the apparatus to the nail gun or the screw gun. Also in one embodiment the first plate and the second plate are made from molding plastic or from machining light weight metal. Also in one embodiment the light pointers have on-off switch.

### BRIEF DESCRIPTION OF THE SEVERAL VIEWS OF THE DRAWINGS

FIG. 1 is a perspective view of an aiming apparatus according to an embodiment of the present invention.

FIG. 2 is a perspective view of an aiming apparatus on the nail gun or screw gun according to an embodiment of the present invention.

FIG. 3 is another perspective view of an aiming apparatus according to an embodiment of the present invention.

FIG. 4 is an exploded view of the holder from the base.

FIG. 5 is an exploded view of the light pointers from the holder.

FIG. 6 is an exploded view of the light pointer heads, batteries from the light pointer bodies.

FIG. 7 is a perspective view of the holder.

FIG. 8 is a perspective view of the base.

### DETAILED DESCRIPTION OF THE INVENTION

The inventor provides an apparatus to aim the nails of nail gun or the screws of screw gun. The present invention is described in enabling detail in the following examples, which may represent more than one embodiment of the present invention.

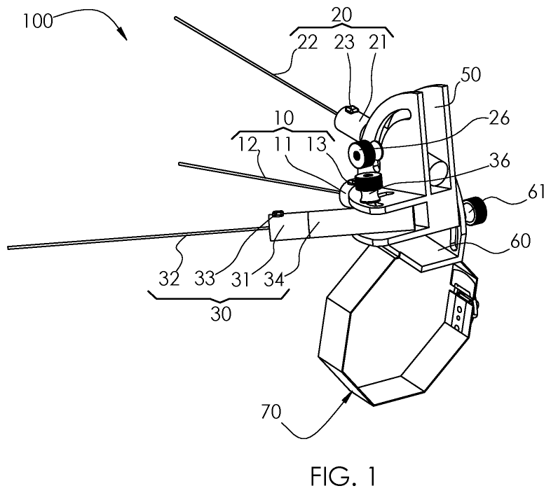

FIG. 1 is a perspective view of an aiming apparatus 100 according to an embodiment of the present invention. Apparatus 100 is in this example an aiming apparatus for nail gun and screw gun. The aiming apparatus 100 comprises 3 light pointers, a holder 50 to hold the light pointers in the place, a base 60 and a belt 70 to tight the aiming apparatus on nail gun or screw gun. The light pointer 10 is showing the aiming location of the nail or screw. The location of the light beam 12 at the wall is the aiming location of the nail or the screw. The light pointer 20 is a vertical reference of the last nail or the last screw in vertical. The light beam 22 is aimed to the last vertical nail or screw as a reference point in vertical. The light pointer 30 is a horizontal reference of the last nail or the last screw in horizontal. The light beam 32 is aimed to the last horizontal nail or screw as the reference in horizontal.

The light pointer 10 comprises a light pointer head 11, a light beam 12 and a light on-off switch 13. The light pointer 20 comprises a light pointer head 21, a light beam 22, a light on-off switch 23 and a light pointer body 24. The light pointer 30 comprises a light pointer head 31, a light beam 32, a light on-off switch 33 and a light pointer body 34. These light pointers can be laser or LED pointer.

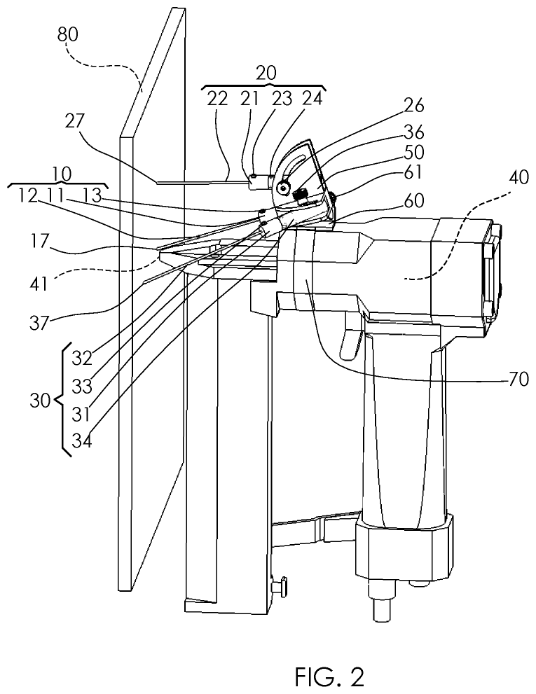

FIG. 2 is a perspective view of an aiming apparatus 100 on the nail gun or screw gun 40 according to an embodiment of the present invention. In this embodiment, the aiming apparatus 100 is tighten to the nail gun or screw gun 40 with the belt 70. Before use the nail gun or screw gun with the aiming apparatus the user need to adjust the aiming apparatus to meet the requirement of the distance between two nails or two screws in vertical and horizontal. The user puts the gun tip 41 of the nail gun or screw gun at the wall 80. The user turns on the light switch 13. The light beam 12 hits the wall 80 at a light point 17. The user loosens the thumb nut 61 and adjusts the position of the light pointer 10 for the light point 17 closes to the gun tip 41, then tight the thumb nut 61 to secure the holder 50 to the base 60. For vertical direction, the user turns on the light switch 23. The light beam 22 hits the wall 80 at a light point 27. The user loosens the thumb nut 26 and adjusts the position of the light pointer 20 for the distance from the light point 27 to the light point 17 meets the requirement of the vertical distance between two nails or two screws. For horizontal direction, the user turns on the light switch 33. The light beam 32 hits the wall 80 at a light point 37. The user loosens the thumb nut 36 and adjusts the position of the light pointer 30 for the distance from the light point 37 to the light point 17 meets the requirement of the horizontal distance between two nails or two screws.

After adjustment the user starts to use the nail gun or screw gun with the aiming apparatus. For vertical the user aims the light point 27 to the last vertical nail or screw and shoots the nail or screw. The vertical distance was adjusted so the distance between the first and the second nail or screw will meet the vertical requirement. For horizontal the user aims the light point 37 to the last horizon nail or screw and shoots the nail or screw. The horizontal distance was adjusted so the distance between the first and the second nail or screw will meet the horizontal requirement. If the user needs only the vertical distance meet the requirement, the user can turns off the switch 33 of the horizontal light pointer 30. Or if the user needs only the horizontal distance meet the requirement, the user can turns off the switch 23 of the vertical light pointer 20.

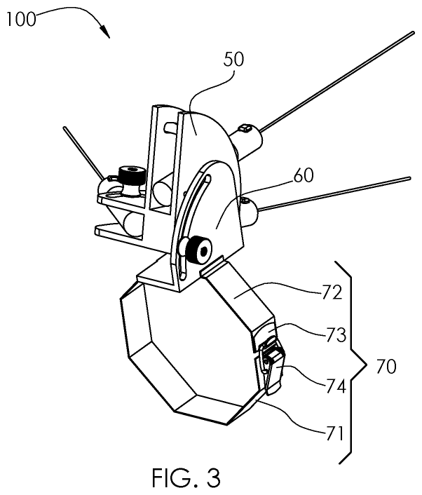

FIG. 3 is another perspective view of an aiming apparatus 100 according to an embodiment of the present invention. It shows the detail of the belt 70. The belt 70 comprises a belt 71, a belt 72, a latch 74 and a hook 73. One end of the belt 71 attaches to the base 60, other end of the belt 71 attaches to the latch 74. One end of the belt 72 attaches to the base 60, other end of the belt attaches to the hook 73.

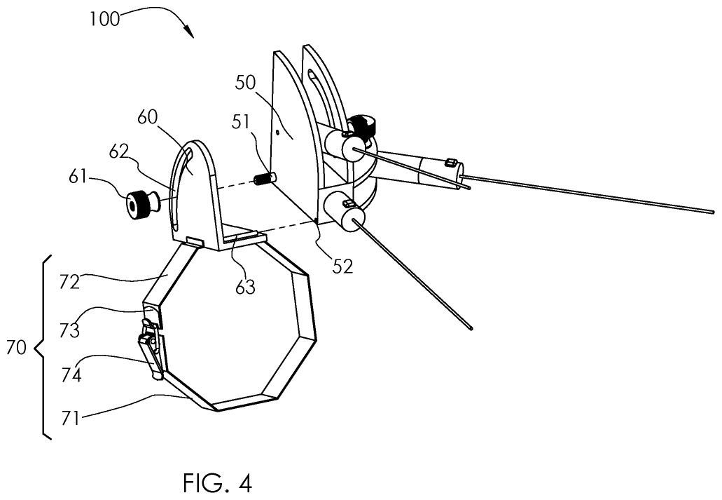

FIG. 4 is an exploded view of the holder 50 from the base 60. The holder 50 attaches to the base 60 with a hole 52 on the holder 50 and a pin 63 on the base 60. The holder 50 can rotate around the pin 63. A shoulder threaded pin 51 on the holder 50 slides on a slot 62 of the base 60. The thumb nut 61 is used to secure the holder 50 on the base 60 by tighten on the shoulder threaded pin 51.

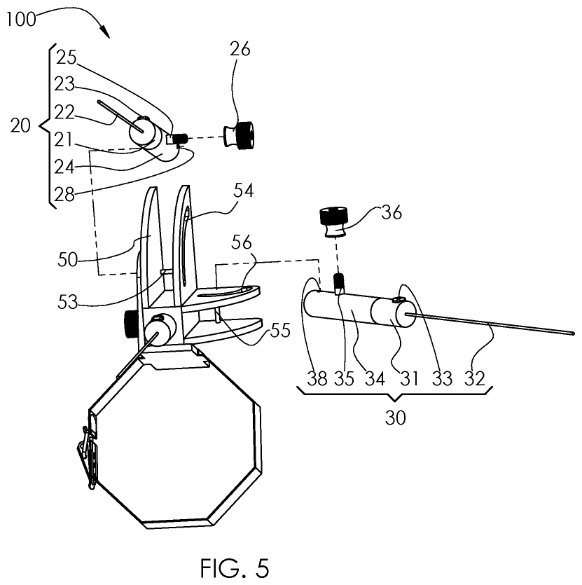

FIG. 5 is an exploded view of the vertical light pointer 20 and the horizontal light pointer 30 from the holder 50. The light pointer 20 attaches to the holder 50 with a hole 28 on the light pointer 20 and a pin 53 on the holder 50. The vertical light pointer 20 can rotate around the pin 53. A shoulder threaded pin 25 on the light pointer 20 slides on a slot 54 of the holder 50. The thumb nut 26 is used to secure the light pointer 20 on the holder 50 by tighten on the shoulder threaded pin 25. The horizontal light pointer 30 attaches to the holder 50 with a hole 38 on the light pointer 30 and a pin 55 on the holder 50. The light pointer 30 can rotate around the pin 55. A shoulder threaded pin 35 on the light pointer 30 slides on a slot 56 of the holder 50. The thumb nut 36 is used to secure the light pointer 30 on the holder 50 by tighten on the shoulder threaded pin 35.

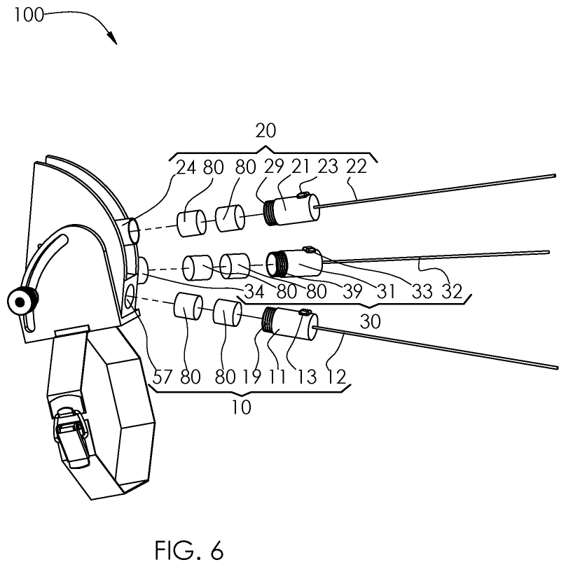

FIG. 6 is an exploded view of the light pointer head 11, batteries 80 from a light pointer body 57; the light pointer head 21, batteries 80 from the light pointer body 24; light pointer head 31, batteries 80 from the light pointer body 34. The light pointer head 10 is tightening to the light pointer body 57 with a thread 19. The light pointer head 21 is tightening to the light pointer body 24 with a thread 29. The light pointer head 31 is tightening to the light pointer body 34 with a thread 39.

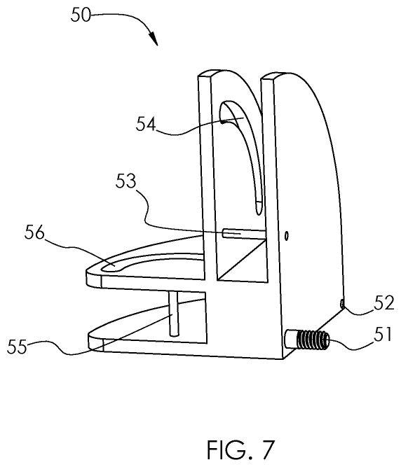

FIG. 7 is a perspective view of the holder 50 showing the hole 52, the shoulder threaded pin 51, the pin 53, the pin 55, the slot 54 and the slot 56.

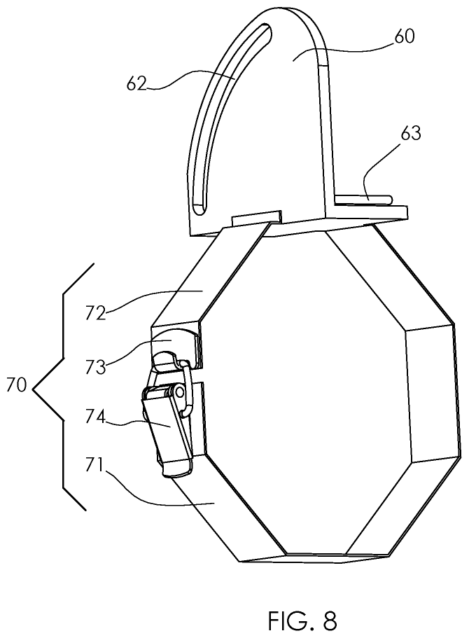

FIG. 8 is a perspective view of the base 60 showing the pin 63, the slot 62 and the belt 70.

It will be apparent to one with skill in the art that the aiming apparatus for nail gun or screw gun of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. An aiming apparatus for nail gun or screw gun comprising;
two or more light pointers, wherein a first light pointer showing the aiming location of the nail or screw, other light pointers referencing to the last nail or screw;
a first plate to hold the light pointers;
a second plate to secure the first plate in place;
a belt, wherein the belt attached to the second plate, the said belt using to tighten the aiming apparatus on the nail gun or screw gun.

2. The apparatus of claim 1, wherein the apparatus has three light pointers, the first light pointer showing the aiming location of the nail or screw, the second light pointer referencing to the last vertical nail or screw, the third light pointer referencing to the last horizontal nail or screw.

3. The apparatus of claim 1, wherein the distance between light beams of light pointers are adjustable.

4. The apparatus of claim 1, wherein the light pointers are laser pointers.

5. The apparatus of claim 1, wherein the light pointers are LED pointers.

6. The apparatus of claim 2, wherein the distances are adjustable between light beams of the first light pointer and the second light pointer, and between light beams of the first light pointer and the third light pointer.

7. The apparatus of claim 6, wherein the first plate is L shape, the first plate comprising:
a hole with thread to secure the first light pointer in place; and
a first pin for the second light pointer rotation to change the distance between the first light beam and the second light beam vertically, a thumb nut to tighten the second light pointer in place; and
a second pin for the third light pointer rotation to change the distance between the first light beam and the third light beam horizontally, a thumb nut to tighten the third light pointer in place;
the second light pointer and the third light pointer comprising a hole for rotation and a shoulder threaded pin for tighten in place.

8. The apparatus of the claim 7, wherein the second plate comprising a pin for the first plate rotation and a thumb nut to tighten the first plate in place;
the first plate comprising a hole for rotation to adjust the location of the first light beam and a shoulder threaded pin for tighten in place.

9. The apparatus of the claim 8, wherein the belt attaches to a latch to tighten the apparatus to the nail gun or the screw gun.

10. The apparatus of the claim 7, wherein the first plate and the second plate are made from molding plastic or from machining light weight metal.

11. The apparatus of the claim 7, wherein the light pointers have on-off switch.
